(19) United States
(12) Patent Application Publication
(10) Pub. No.: US 2007/0201945 A1
(43) Pub. Date: Aug. 30, 2007

(54) Coupling rod for a stabilizer assembly

(76) Inventor: Rudiger Scharioth, Attendorn (DE)

Correspondence Address: Wyatt, Gerber & O'Rourke, LLP, 99 Park Avenue, New York, NY, 10016, US

(21) Appl. No.: 11/706,096

(22) Filed: Feb. 14, 2007

(30) Foreign Application Priority Data
Feb. 14, 2006 (DE) 102006006929.3-21

(51) Int. Cl. F16C 11/00

(52) U.S. Cl. 403/132; 403/122

(57) ABSTRACT

A coupling rod, more particularly for a stabilizer assembly in a motor vehicle, which comprises joints at its respective ends, wherein at least one of the joints of the coupling rod is an elastomer-metal joint which consists of an inner ball element an annular elastomer element and an outer sleeve part wherein the elastomer element is firmly connected to the ball element and to the sleeve part.

### BACKGROUND OF THE INVENTION

The invention relates to a coupling rod, which is particularly suited for use in a stabilizer assembly for a motor vehicle. Generally, stabilizer assemblies comprise a stabilizer with a torsion bar spring portion and two symmetrically designed lever arms at its ends, as well as coupling rods which are arranged at the free ends of the lever arms and each comprise a first joint for being articulated at the respective lever arm and a second joint for being articulated at the movable part of one of the wheel suspensions of an axis of the motor vehicle.

Stabilizer assemblies substantially serve to suppress the lateral inclination of the vehicle when negotiating curves in that the effect of the stabilizer avoids a compression movement on one side and a rebound movement on the opposite side. A transversely positioned stabilizer supported in rubber can be connected to the two wheel suspensions in such a way that each spring movement of one of the wheel suspensions of an axle can be transmitted by means of the stabilizer. In addition, each spring movement can be reduced by the torsion bar spring portion to the other wheel suspension of the axle. The stabilizer in this case can comprise two symmetrically bent ends which can be connected directly to movable parts, such as steering arms or spring struts of the wheel suspension. In addition, the bent ends can be connected by two coupling rods to the movable parts of the wheel suspension, i.e. steering arms or spring struts. For connecting the ends of the Coupling rods, coupling rods of this type can comprise ball joints at the lever arms of the stabilizer and on the wheel suspension for the connecting the ends of the coupling rods. Such ball joints can have a ball member with an attached fixing journal which can slide angularly and rotatably in a ball socket made of bearing metal or plastic. The ball joints can be inserted into eyes at the ends of the coupling rods. Ball joints of this type are relatively complicated and expensive to produce. Furthermore, they are subject to mechanical wear.

Coupling rods have also been produced with simple elastomer bearing elements wherein an inner fixing journal is held in an annular cylindrical elastomer sleeve which, in turn, is surrounded by a metallic sleeve member. The fixing journal and the sleeve member are connected in a material-locking way to the elastomer sleeve. The bearing elements are inserted into eyes at the ends of the coupling rod. The bearing elements can carry out small angular movements only, so that the range of application of such coupling rods is limited.

### OBJECT OF THE INVENTION

It is therefore an object of the present invention to provide a stabilizer assembly wherein at least one of the joints of the coupling rod is an elastomer-metal joint having an inner ball element, an annular elastomer element and an outer sleeve part, wherein the rubber element is firmly connected to the ball element and the sleeve part.

In this way, the expensive sliding ball joints which have been used so far are replaced by cost-effective and wear-resistant elastomer-metal joints which can achieve sufficient angular movements for the required function of the coupling rod at the lever arms of the stabilizer assembly. In addition, the returning forces do not adversely affect the function of the stabilizer assembly.

To the extent that the expression “ball element” is used herein to describe the inner component to which there can be bolted a stabilizer or another wheel suspension element of a motor vehicle, this terms is not limited to perfectly spherical members, but includes ball-like members such a ellipsoids or cylindrical members with end cones at both ends, among other things.

The spherical shape of the inner component greatly improves the angular mobility of the elastomer-metal joint. Further improvement of the angular mobility can be achieved in that the inner shape of the outer sleeve part can be adapted to the spherical shape in such a way that the elastomer element comprises a substantially uniform wall thickness, i.e. it is provided in the form of a ball socket portion.

In DE 40 25 100 A1, a rubber-metal bearing is described having an inner spherical formed member. However, the rubber member surrounding the formed member comprises a variable wall thickness, both in the longitudinal direction and around the circumference. Instead of an annular sleeve element, two half-sockets are arranged at a circumferential distance from one another. This type of bearing is inappropriate for use in coupling rods.

The substantially uniform wall thickness of the elastomer element as used in the invention is provided in both the longitudinal direction and around the circumference.

According to another embodiment, it is an object to provide the coupling rods, wherein the joint to be connected to the wheel suspension is an elastomer-metal joint. Such an embodiment is particularly suitable for being used in stabilizer assemblies for McPherson wheel suspensions.

The coupling rods can be comprised of a round bar, or a bar having a profiled cross-section with welded-on eyes for receiving one or more elastomer-metal joints. When formed by casting or similar methods, the coupling rods can comprise integrally formed-out eyes for receiving elastomer-metal joints. Generally, the sleeve element can be pressed into the respective eye.

Alternatively, the ball element can comprise a ball member with an adjoining threaded journal, or a ball member with a through-aperture, in each case for producing a threaded connection. Furthermore, the elastomer-metal joint, can additionally comprise an annular elastomer element and a sleeve part to be firmly inserted into a receiving element of the coupling rod. The elastomer element is preferably firmly connected to the ball element and the sleeve part by vulcanisation.

The ball element can be provided with corrosion protection means, such as zinc nickel. The ball element can also be coated with an adhesion promoting system and, like the outer sleeve, can be inserted into a mould in a suitably associated way into which mould a free-flowing elastomer can be introduced. Elastomers can be completely vulcanised within a few minutes at a temperature of approximately 180° C. Subsequently, the sleeve can be calibrated to its final dimensions in a suitable device. Such calibrates is provided subsequently since shrinkage typically occurs inside the elastomer during vulcanisation and to subject the elastomer to a compressive prestress. The sleeve can be produced from a tubular portion through a forming operation. Additionally, the sleeve can consist of two semi-annular half-sockets, or can be formed from a strip of metal plate, with the half-sockets or strips of metal plate being closed at the joins in a suitable way.

The ball element can be produced by welding a threaded journal to a finished solid ball (e.g. a bearing ball. Alternatively, the ball element can be forged as a hollow element and then machined. It is also possible to produce the hollow ball by cold extrusion, with a threaded journal subsequently being pressed into the ball. The ball element does not necessarily have to consist of metal, but it can also be produced as a moulded member made of plastics or rubber having sufficient hardness and formed to enclose the threaded journal. Cylindrical projections having a smaller diameter can be formed on to the ball element in the direction of the threaded journal and the through-aperture respectively. The cylindrical projections can serve as axial assembly stops for the rubber-elastomer bearing and, optionally, can also form a stop for the sleeve element to delimit angular movement.

### BRIEF DESCRIPTION OF THE DRAWINGS

An inventive stabilizer assembly, an inventive coupling rod and inventive elastomer-metal joints are illustrated in the drawings and will be described below.

FIG. 1 shows an inventive stabilizer assembly in a 3D illustration.

FIG. 2 shows in inventive coupling rod for an assembly according to FIG. 1.

FIG. 3 shows an inventive elastomer-metal joint with a threaded journal in the embodiment according to FIG. 2 in the form of a detail
a) in an end view
b) in a longitudinal section

FIG. 4 shows an inventive elastomer-metal joint with a threaded journal in a second embodiment.

FIG. 5 shows an inventive elastomer-metal joint with a threaded journal in a third embodiment.

FIG. 6 shows an inventive elastomer-metal joint with a threaded journal in a fourth embodiment.

FIG. 7 shows an inventive elastomer-metal joint with a through-aperture in the embodiment according to FIG. 2 in the form of a detail.

FIG. 8 shows an inventive elastomer-metal joint with a though-aperture in a second embodiment.

FIG. 9 shows an inventive elastomer-metal joint with a though-aperture in a third embodiment.

FIG. 10 shows an inventive elastomer-metal joint with a though-aperture in a fourth embodiment.

### DETAILED DESCRIPTION

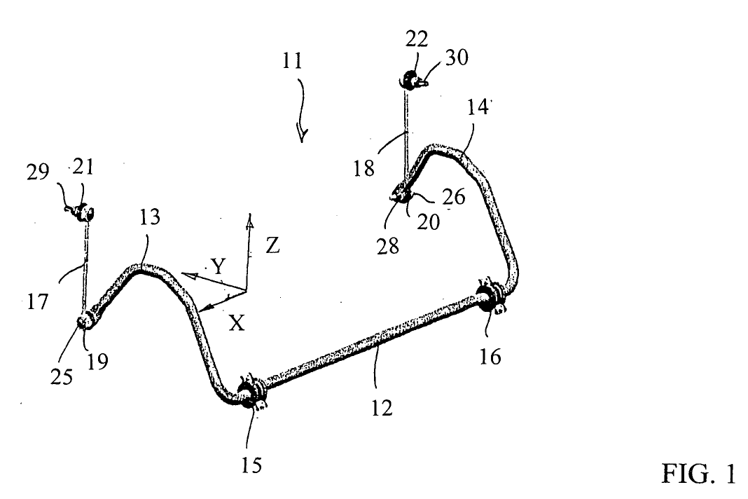

FIG. 1 illustrates an inventive stabilizer assembly 11 which is intended for a motor vehicle, with the indicated X-direction being the longitudinal direction of the motor vehicle and the indicated Y-direction being the transverse direction of the motor vehicle. The Z-direction can be the vertical axis of the motor vehicle, but this is not essential; the vertical axis of the motor vehicle can also form a different angle relative to the X-Y plan.

The stabilizer 11 comprises a straight torsion bar spring portion 12 as well as two cranked lever arms 13, 14 bent relative thereto at approximately right angles. The torsion bar spring portion can be held in two rubber-metal bearings 15, 16 which are secured in the motor vehicle on a transverse axis, such as in the engine compartment or at the underbody. The two lever arms 13, 14 can serve to provide a connection with the two wheel suspensions of an axle of a motor vehicle, which can be the front axle or the rear axle. The movements of the two wheel suspensions are transmitted to the lever arms 13, 14 via two coupling rods 17, 18 which are connected via first joints 19, 20 to the free ends of the lever arms 13, 14 and which can be connected via second joints 21, 22 to the two wheel suspensions. The first joints 19, 20 of the coupling rods 17, 18 are connected by inserted bolts 25, 26 and nuts, of which only one (28) can be seen, to the free ends of the lever arms 13, 14. The second joints 21, 22 can comprise threaded journals 29, 30, for example, which are directly and firmly connected to the ball elements of the elastomer-metal joints, which will be shown later.

One purpose of the different orientation of the threaded journals 29, 30 in the X-direction is to show that the angular position of the threaded journal is freely selectable and does not necessarily have to extend parallel to the transverse direction Y. Generally, the portion can coincide with the transverse direction Y. The design of the coupling rods 17, 18 can permit the first and the second joint to be rotatable relative to one another with reference to the longitudinal direction of the coupling rods, but preferably, depending on the type of wheel suspension, specify a certain angular position, with the axes of the threaded journals and of the through-apertures being positioned in the joints perpendicularly relative to the axis Z of the coupling rods 17, 18.

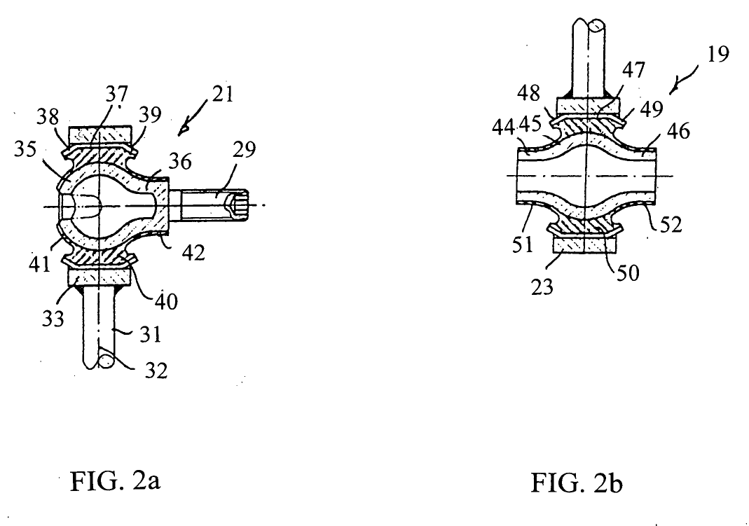

FIG. 2 shows details of one of the coupling rods, given the reference number 17, in partial sections. A round bar 31 and two eyes 23, 33 are shown which are welded thereto and which each comprise a cylindrical inner aperture. In one embodiment, the round bar 31 and the eyes 23, 33 are welded to one another, but they can also be an integral casting or formed part among other things. The round bar 31 is shown in a broken condition and, depending on the assembly conditions and the geometry of the wheel suspensions, the axes of the eyes 23, 33 can be in a position rotated in any direction relative to the longitudinal axis of the round bar 31. The elastomer-metal joint 21 can be pressed into the first eye 33 and can comprise a hollow ball element with a cylindrical projection 36 on to which there is welded a threaded journal 29. Furthermore, the joint 21 comprises a sleeve part 37 which is cylindrical in the central region and comprises two conical end portions 38, 39. The inner shape of the sleeve part 37 is adapted to the shape of the ball element 35 by means of the conical end portions 38, 39. In such a manner an annular elastomer element 40, which is positioned between the conical end portions 38, 39 and the ball element 35 and which is connected to both parts by vulcanisation, comprises uniform wall thickness substantially along its length and around the circumference. The elastomer element 40 comprises adjoining collars 41, 42 with a small wall thickness, which fully enclose the ball element 35 and the projection 36 and thus achieve improved connection conditions and provides corrosion protection.

The elastomer-metal joint 19 can be inserted into the second eye 23 and comprises a ball element 45 which can be provided in the form of a hollow ball with two sleeve-shaped projections 44, 46 which form a through-aperture for a bolt. The elastomer-metal joint 19, comprises a cylindrical sleeve element 47 in its central region with conical end portions 48, 49 between which an annular elastomer element 50 is provided. Elastomer element 50 comprises collar attachments 51, 52 which cover the entire length of the ball element 45 and its projections. Elastomer element 50 can be provided with an approximately uniform wall thickness along its length and its circumference in the region of connection with the ball element and the sleeve, as a result of the shape of the sleeve 47. This arrangement can provide a homogenous load on the rubber material in the case of joint movements.

FIG. 3 shows details of the elastomer-metal joint 21 shown in FIG. 2, with identical parts having been given identical reference numbers. FIG. 3a shows the angle of torsion of the ball element with the threaded journal relative to the sleeve in a minimum size of ±30°. FIG. 3b shows a continuous maximum joint angle of the journal axis relative to the sleeve element of at least 45° relative to the longitudinal axis.

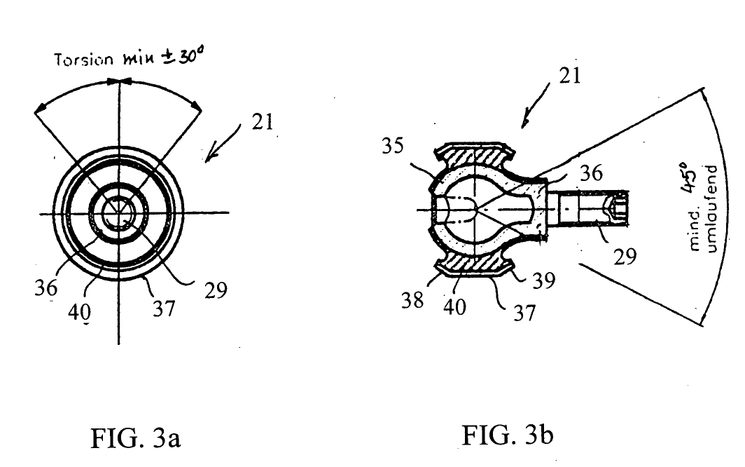

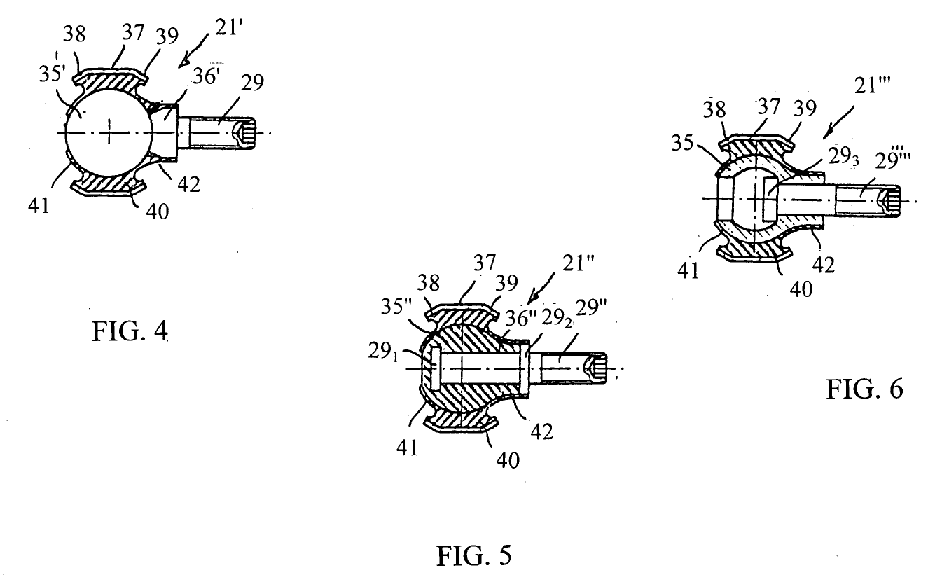

FIG. 4 illustrates a further embodiment of an elastomer-metal joint 21′. The ball element 35′ is provided as a solid ball, and the projection 36′ is provided in the form of a welded-on or glued-on solid journal. The threaded journal 29, the sleeve element 37 and the elastomer element 40 can be similar to those shown in the embodiment shown in FIG. 3.

FIG. 5 illustrates a further embodiment of an elastomer-metal joint 21″. The threaded journal 29″ can extend integrally into the interior of the ball element 35′ and carries two radial flanges 29₁, 29₂. The threaded journal 29″ can be at least partially enclosed by a plastic or rubber member or by a member consisting of light metal which has a spherical shape and comprises a projection 36″. The ball element can also be pressed on or bolted to the threaded journal. The shape of the sleeve element 37 and the shape and design of the elastomer element 40 can be similar to those shown in FIG. 3.

FIG. 6 shows a further embodiment of an elastomer-metal joint 21′″, wherein a ball element 35 and a projection 36 substantially correspond to the embodiment according to FIG. 2, but a threaded journal 29′″ and a pin head 29₃ are inserted, with the connection with the ball element 35 being a loosely joined, pressed or glued connection.

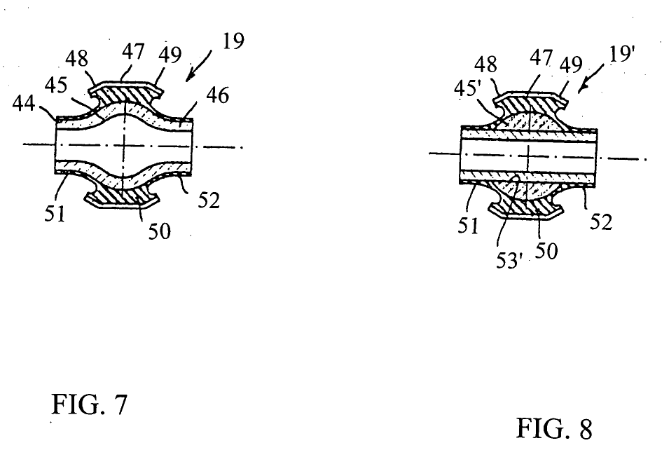

FIG. 7 shows a detail in a longitudinal view of a further embodiment of an elastomer-metal joint 19, similar to that shown in FIG. 2. Corresponding components are given identical reference number. To that extent, reference is made to the description of FIG. 2.

FIG. 8 illustrates a further embodiment of an elastomer-metal element 19′. An inserted tubular portion 46′ is provided passing through a through-bore 63′ in the ball element 45′. The connection between these two parts can be a press-fit, or the ball element 45′ can consist of a different material, i.e. rubber, plastics or light metal, being either formed on or fabricated by injection-moulding. The design of the sleeve 47 and of the rubber element 50 can be similar to those shown in the embodiment according to FIG. 2.

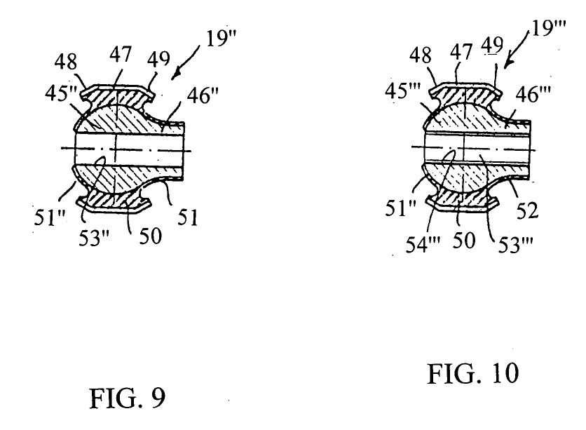

FIG. 9 shows a further embodiment of an elastomer-metal joint 19″ with a through-aperture 53″ in the ball element 45″. The ball element 45″ comprises a projection 46″ on one side and thus has a shape which is similar to that in the joint 19 according to FIG. 2. However, the elastomer element 50″ comprises a differently formed collar 51″ next to the collar 52.

FIG. 10 illustrates a further embodiment of an elastomer-metal element 19′″, being similar to the joint according to FIG. 7. However, the through-aperture 53′″ is provided with an inner thread 54′″. Instead of using a bolt/nut connection, the joint can thus be fixed to a corresponding attachable part by means of a head screw.

The annular enclosure of the ball element 35, 45 provided by the elastomer element 30, 50 is preferably closed around the circumference, but, in a modified embodiment it can also comprise individual interruptions around the circumference in various embodiments.

1. A coupling rod, comprising a plurality of joints at its respective ends, wherein at least one of the plurality of joints is an elastomer-metal joint comprising an inner ball element, an annular elastomer element and an outer sleeve part, wherein the annular elastomer element is firmly connected to the inner ball element and to the outer sleeve part.

2. A coupling rod according to claim 1, wherein a first joint and a second joint of the plurality of joints are elastomer joints comprising an inner ball element, an annular elastomer element and an outer sleeve part, wherein the annular elastomer element is connected to the inner ball element and the outer sleeve part.

3. A coupling rod according to claim 1, wherein the annular elastomer element is connected in a material-locking way to the inner ball element and to the outer sleeve part.

4. A coupling rod according to claim 1, further comprising an eye, said eye having a bore, and wherein the outer sleeve part further comprises at least one cylindrical portion which is pressed into the bore in the eye of the coupling rod.

5. A coupling rod according to claim 1, further comprising a threaded journal firmly connected to the inner ball element.

6. A coupling rod according to claim 1, wherein the inner ball element further comprises a through-aperture.

7 A coupling rod according to claim 5, wherein the inner ball element is formed as an open hollow ball having a projection for fixing the threaded journal.

8. A coupling rod according to claim 7, wherein the projection is formed out of the hollow ball.

9. A coupling rod according to claim 1, wherein the inner ball element is formed as a solid ball.

10. A coupling rod according to claim 9, further comprising a threaded journal, and a projection, said projection connected to the inner ball element and formed so as to be integral with the threaded journal.

11. A coupling rod according to claim 5, wherein the ball element is formed on an extension of the threaded journal.

12. A coupling rod according to claim 5, wherein the inner ball element is a hollow ball and wherein the threaded journal is inserted into the inner ball element.

13. A coupling rod according to claim 1, wherein the inner ball element is a hollow ball comprising a through-aperture and two sleeves.

14. A coupling rod according to claim 1, wherein the inner ball element comprises a through-aperture and a tube portion, and wherein the tube portion is inserted into the through-aperture.

15. A coupling rod according to claim 1, wherein the inner ball element further comprises a projection and a through-aperture.

16. A coupling rod according to claim 14, wherein the through-aperture further comprises an inner thread.

17. A coupling rod according to claim 1, further comprising a bar having two welded-on eyes, each of said eyes being formed for receiving a joint.

18. A coupling rod according to claim 1, further comprising a bar having two formed-on eyes, each of said eyes being formed for receiving a joint.
